(19) United States
(12) Patent Application Publication
(10) Pub. No.: US 2014/0246213 A1
(43) Pub. Date: Sep. 4, 2014

(54) AIRCRAFT FIRE EXTINGUISHING SYSTEM AND METHOD

(71) Applicant: Moshos Karagounis, Athens (GR)

(72) Inventor: Moshos Karagounis, Athens (GR)

(21) Appl. No.: 14/279,966

(22) Filed: May 16, 2014

Related U.S. Application Data
(63) Continuation-in-part of application No. 12/738,535, filed on Apr. 16, 2010, now abandoned.

(51) Int. Cl. A62C 3/02

(52) U.S. Cl. CPC A62C 3/0242
USPC 169/53

(57) ABSTRACT

The aircraft fire extinguishing system and method applies to helicopters having suspended or built-in liquid reservoir. The innovation lies on the transformation of the firefighting liquid into artificial rain in the form of an umbrella having diameter approximately equal to the diameter of the helicopter's propeller, with adjustable density and duration. The rain creation mechanism in both cases consists of a hollow propeller with two wings where the liquid is guided hydraulically. The liquid jets through nozzles which are in counterpoised arrangement causing the initial revolution of the hollow propeller. This rotation is accelerated and stabilized from the downstream of the helicopter's propeller. The reservoir is suspended from a helicopter's hook by a stretcher using four chains. The built-in reservoir includes an inclined or retractable metallic pipe which the hollow propeller is adapted through a free rotation mechanism. The hollow propeller is set into motion by means of a pressure pump.

### CROSS-REFERENCE TO RELATED APPLICATION

This application is a continuation-in-part under 35 U.S.C. §120 based upon co-pending U.S. patent application Ser. No. 12/738,535, filed on Apr. 16, 2010. Additionally, this present application claims the benefit of priority of co-pending U.S. patent application Ser. No. 12/738,535, filed on Apr. 16, 2010. The entire disclosure of the prior application(s) is incorporated herein by reference.

### BACKGROUND OF THE INVENTION

1. Field of the Invention

The present invention relates to an aircraft fire extinguishing system and method for use in connection with extinguishing fires using aircraft. The purpose of the present invention, which henceforth will be mentioned for brevity as the RAINSTORM method, is to create, by means of firefighting helicopters, conditions of an artificial heavy rainstorm equivalent to a real rainstorm, which one would have wished to break out in reality during the fire.

The technical implementation field of the RAINSTORM method is the firefighting even in locations where firefighting helicopters cannot, or are not permitted to operate, i.e. the fringes of inhabited areas, isolated residencies in tree lines, areas with High Voltage transportation pylons, areas with trapped vehicles, people, animals, farming installations, areas where Land Forces operate and in general where there is no risk of damage and loss of life by creating an artificial rain phenomenon of controlled intensity and duration.

The advantages of the RAINSTORM method allow preventive spraying or decontaminations eve during the night.

2. Description of the Prior Art

Present Day Situation: Two types of helicopters are used for firefighting are under use today: Those which carry water inside the fuselage, similar to the equivalent airplanes, and those which use suspended buckets.

In both cases dropping of water takes place in a few seconds with the form of a waterfall and, if we take into consideration, in many cases, the unfavorable conditions of visibility, it is very likely and/or inevitable to miss the target, which is translated in loss of the entire water load as well as in precious time, within which the fire gains ground.

Moreover this way of firefighting, with great volumes of water falling with high speed to the ground, which cannot be applied in the above mentioned cases, has also the basic disadvantage that only a small percentage of the falling water is used for firefighting.

Furthermore, during the violent drop of the water, a vacuum is created attracting air with the form of siphon which revives the fire.

It must be mentioned and pointed out that the biggest effectiveness of water, when it is used for firefighting, is achieved with the uniform rainfall above the fire area under form of droplets, so as these to have the largest surface in order to evaporate very rapidly, absorbing from the fire the biggest amount of heat, decreasing respectively the temperature of the area, which in combination with the rarefaction of oxygen, due to the interjection of water vapors, will contribute in the repression and the extinguishment of Fire in the smallest possible time.

Finally it must also be pointed out that the helicopters, despite their relatively small carrying capacity compared to the firefighting airplanes, have two basic and undeniable advantages: Fly with very small speeds-up to hovering speed, as well as to be able to land/descend vertically, in order to be supplied with water and fuel, in relatively very small spaces.

Furthermore, the RAINSTORM method can be used in cases of preventive spraying with water or retarding liquid, as well as for decontamination of large areas.

The safety of the RAINSTORM method allows the aircraft to operate during the night as well, thus giving a unique advantage.

While the above-described devices fulfill their respective, particular objectives and requirements, the aforementioned patents do not describe an aircraft fire extinguishing system and method that allows extinguishing fires using aircraft.

Therefore, a need exists for a new and improved aircraft fire extinguishing system and method that can be used for extinguishing fires using aircraft. In this regard, the present invention substantially fulfills this need. In this respect, the aircraft fire extinguishing system and method according to the present invention substantially departs from the conventional concepts and designs of the prior art, and in doing so provide an apparatus primarily developed for the purpose of extinguishing fires using aircraft.

### SUMMARY OF THE INVENTION

In view of the foregoing disadvantages inherent in the known types of firefighting helicopters now present in the prior art, the present invention provides an improved aircraft fire extinguishing system and method, and overcomes the above-mentioned disadvantages and drawbacks of the prior art. As such, the general purpose of the present invention, which will be described subsequently in greater detail, is to provide a new and improved aircraft fire extinguishing system and method and method which has all the advantages of the prior art mentioned heretofore and many novel features that result in an aircraft fire extinguishing system and method which is not anticipated, rendered obvious, suggested, or even implied by the prior art, either alone or in any combination thereof.

Firefighting by means of the RAINSTORM method.

The RAINSTORM method was devised, studied and engineered in such a way in order to avoid all disadvantages and weaknesses that we face today during firefighting with helicopters, and at the same time to exploit in the biggest possible degree the particular abilities of helicopters, as well as, and the firefighting capabilities of water.

The Key for confronting the above mentioned disadvantages in the present situation, as well as the combined exploitation of helicopter and water capabilities in firefighting, in order to obtain the biggest firefighting Result, constitutes.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

Without any doubt, water which is abundant in nature is a fire's worst enemy, since it is certain that no forest, tree line, bush or grassland fire can manifest, keep up and most importantly expand itself in the presence of rain.

It must be pointed out that every liter of water entering in the fire in the shape of droplets takes on more than 450 kcal, which drastically reduce not only the fire's temperature but the oxygen as well with the superheated vapors created.

It is also indisputable that present day helicopters equipped with sophisticated night flight technology, constitute the only means which in virtually no time, in comparison with land transportation, can safely approach a raging fire, in hard to reach or even inaccessible mountain areas, and at the same time have a full perspective of the fire's extent and rate and direction of expansion.

The purpose of the RAINSTORM system is the conversion of all the water mass carried by a helicopter into artificial rain in the form of an umbrella, with a diameter approximately equal to that of the helicopter's main rotor (12-15 m), and with the characteristics of a strong rainfall (storm) of controllable intensity and duration, and with the capability of stopping and resuming the rainfall at will by the helicopter's operator.

Further target of the RAINSTORM system is the reducing of water dropping to 1-3 m3/min, and increasing the water quantity by reducing the helicopter's speed, or by circling over the fire in order to fully vaporize the water.

It is emphasized that today, helicopters used in firefighting drop 3 m3 of water in only 3 sec in the shape of a cataract. This large amount of water hits the ground with great speed, causing serious damage, and in essence the water is either lost or goes unexploited.

It is also emphasized that for economical, ergonomically, as well as in order to reduce the time of the helicopter's effective intervention (reaction time), the RAINSTORM system uses helicopters with medium lifting capacity between 1.0-3.5 tons.

It is more that certain that once the transported by the helicopter water mass is transformed into harmless rainfall, the issue of the helicopter's suspension of operation during the night hours is automatically solved, since modern helicopters are equipped with night flight technology. Thus, the fire's destructive force, which is much larger at night than during the daytime, will be minimized. Furthermore, in the presence of harmless rainfall, the helicopters with RAINSTORM equipment will be able to operate simultaneously with land fire fighting forces, even in inhabited areas where there are trapped vehicles, cultivated land, roads, high voltage power lines, livestock, and in general anytime and anyplace with no risk of damage or loss of life, by utilizing an artificial rain phenomenon of controlled intensity and duration.

In order to achieve the above mentioned objectives, the RAINSTORM system was designed and engineered for medium lifting capacity helicopters, and consists of the following inextricably related to each other subsystems:

a. The suspension stretcher, which is fitted in the helicopter's underside and is hooked onto the helicopter's main hook.

b. The reservoir of the firefighting fluid (water), together with the swing where the reservoir will sit and the chains to which the stretcher and the reservoir will be connected to the helicopter via the stretcher.

c. The rain creation mechanism, which is fitted at the back side of the reservoir.

d. The electrical system using a 12 V DC motor (fed by the helicopter's electrical system), ensuring the smooth operation of the system, controlled by the pilot.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved aircraft fire extinguishing system and method that has all of the advantages of the prior art firefighting helicopters and none of the disadvantages.

It is another object of the present invention to provide a new and improved aircraft fire extinguishing system and method that may be easily and efficiently manufactured and marketed.

An even further object of the present invention is to provide a new and improved aircraft fire extinguishing system and method that has a low cost of manufacture with regard to both materials and labor, and which accordingly is then susceptible of low prices of sale to the consuming public, thereby making such aircraft fire extinguishing system and method economically available to the buying public.

Still another object of the present invention is to provide a new aircraft fire extinguishing system and method that provides in the apparatuses and methods of the prior art some of the advantages thereof, while simultaneously overcoming some of the disadvantages normally associated therewith.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a side plane view of an embodiment of the aircraft fire extinguishing system constructed in accordance with the principles of the present invention, with the phantom lines depicting environmental structure and forming no part of the claimed invention.

FIG. 2 is a top elevational view of the aircraft fire extinguishing system of the present invention.

FIG. 3 is a rear plane view of the aircraft fire extinguishing system of the present invention.

FIG. 4 is a cross-sectional view of the aircraft fire extinguishing system of the present invention taken along the line 4-4 in FIG. 3.

FIG. 5 is a cross-sectional view of the aircraft fire extinguishing system of the present invention taken along line 5-5 in FIG. 4.

FIGS. 6A-C is an in use illustrative view of the aircraft fire extinguishing system and method of the present invention.

FIG. 7 is a top elevational view of a reservoir suspension device of the aircraft fire extinguishing system of the present invention.

FIG. 8 is a cross-sectional view of the reservoir suspension device taken along line 8-8 in FIG. 7.

FIG. 9 is an in use illustrative view of an alternate embodiment aircraft fire extinguishing system and method of the present invention.

FIG. 10 is a side plane view of an alternate embodiment of the aircraft fire extinguishing system of the present invention.

FIG. 11 is a top elevational view of the alternate embodiment aircraft fire extinguishing system of the present invention.

FIG. 12 is side view of the Rain Creation Mechanism of the present invention.

FIG. 13 is an exploded view of the Rain Creation Mechanism.

FIG. 14 is an exploded side view of the Suspended Water Reservoir with Swing.

FIG. 15 is an exploded back view of the Suspended Water Reservoir with Swing.

FIG. 16 is a side view of the Suspension Mechanism from the helicopter's hook.

FIG. 17 is a side and top view of the Suspension Mechanism from the helicopter's hook.

FIG. 18 is a side view of the “RAINSTORM” system—Horizontal Phase (Journey).

FIG. 19 is a side view of the Replenishment Phase from sea, lake or river.

FIG. 20 is a side view of the Rainfall and Fire Fighting Phase.

FIG. 21 is a side view of the Rainfall and Fire Fighting Phase.

The same reference numerals refer to the same parts throughout the various figures.

### DETAILED DESCRIPTION OF THE INVENTION

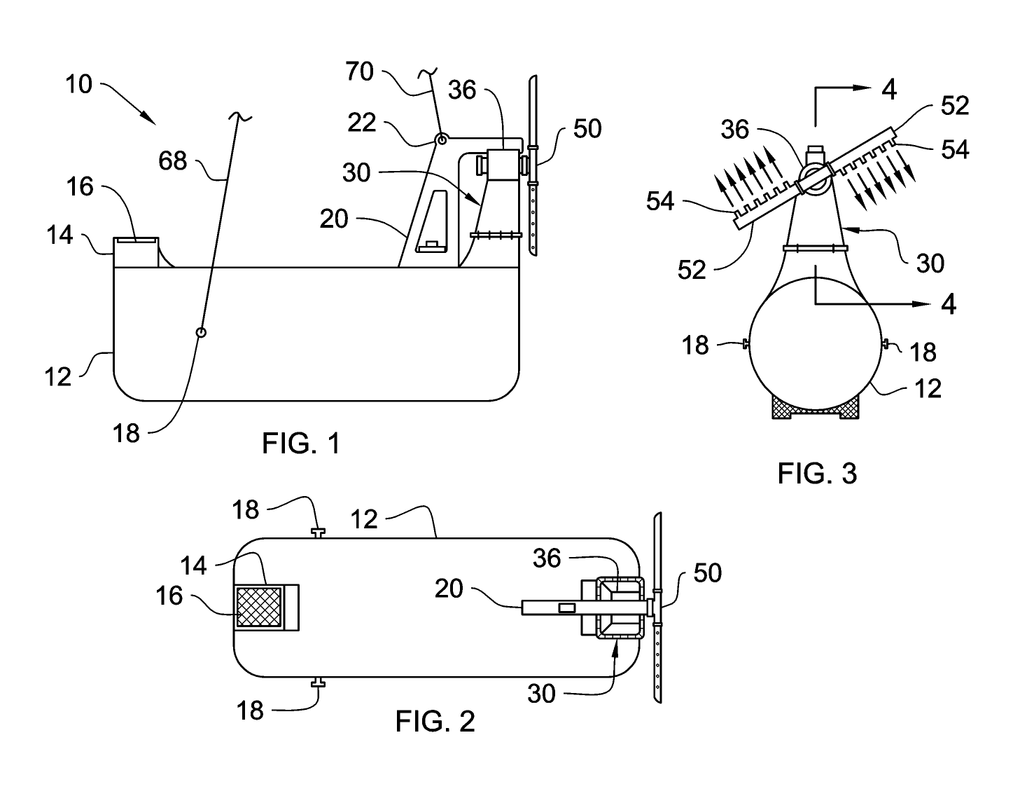

Referring now to the drawings and particularly to FIGS. 1-21, an embodiment of the aircraft fire extinguishing system and method of the present invention is shown and generally designated by the reference numeral 10.

The Water Reservoir with the Artificial Rain Creation Mechanism

It is a cylindrical reservoir 12, in the rear side of which the artificial rain creation and dousing mechanism is adapted. The Schematic Diagrams of the Reservoir and the artificial rain creation mechanism 30 are shown in FIGS. 1-5.

The dimensions of the reservoir 12 and its capacity are standardized in sizes respectively with the lifting capability of helicopters used for firefighting.

The reservoirs 12 are suspended from the helicopters 60 by means of three wire ropes—belts 68, 70, which are fixed, with couplers easy to dismantle, in three points of the reservoir 18, 22, in triangular arrangement, two coupling points 18 on the sides of reservoir 12 and the third 22 in its rear side.

The suspended reservoir 12 has two main components connected to each other with a watertight flange 34, as follows:
The Water Reservoir Unit 10 which is a cylindrical reservoir 12, manufactured from material durable in marine water, having a powerful frame in order to withstand all load strains and vibrations caused by the various helicopter maneuvers especially during the dousing phase.

In the upper front compartment of the reservoir there is a specifically shaped and elevated intake orifice 14 used for the replenishment of the reservoir 12 with water, which, if required, opens and closes automatically during the three phases of operation of the reservoir 12, i.e.: Water filling (Open), Transportation of water (Closed) and firefighting (Open).

The caudal reinforcing fin 20 is fixed in the upper rear side of the reservoir 12. This fin 20 retains the rain creation mechanism 30 from above, in the top of which exists the third point of suspension 22.

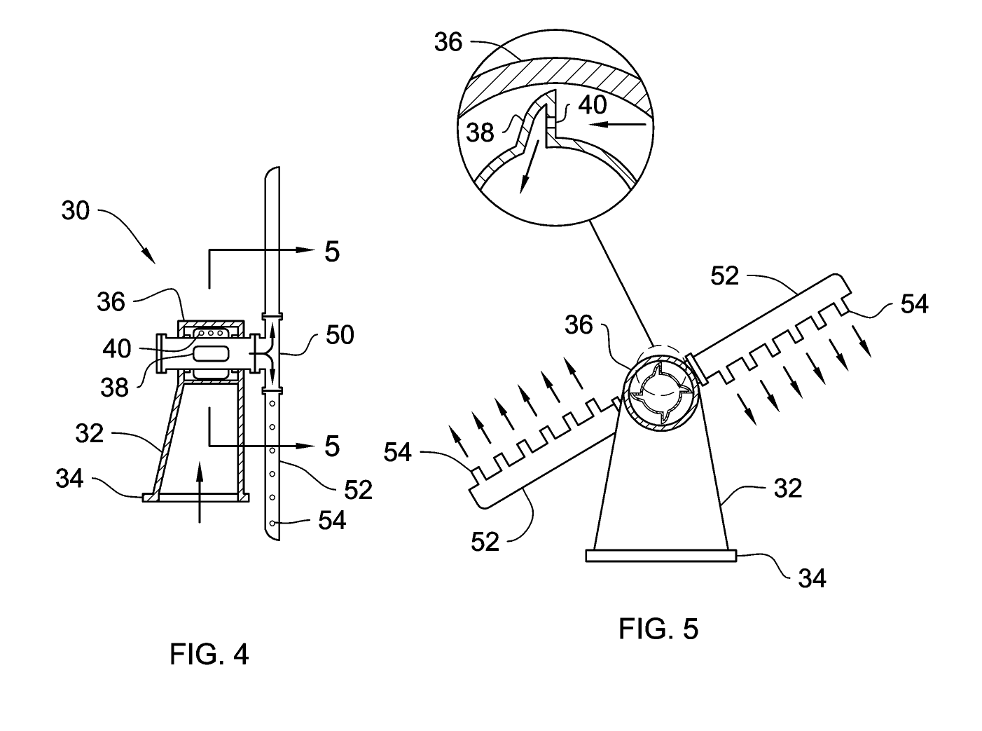

The Rain Creation/Dousing Unit 30, manufactured from stainless material, which includes:
The Conical Pipe 32 which channels the water to the Hydraulic Mechanism 36.
The Hydraulic Mechanism-Water Turbine 36 of the hollow propeller assembly 50, as best illustrated in FIGS. 4 and 5 which is fitted with the bladed trunions 38 with ports 40 for channeling the pressurized water to the hollow propeller assembly 50, and
The hollow propeller assembly 50, which consists of the hollow propeller 52, that is water tightly connected to the trunions 38 of the Hydraulic Mechanism-Water Turbine 36. The hollow propeller 52 has sufficient number of nozzles 54 in each blade having the appropriate diameter, in order that in correlation with the speed and the flight height of the helicopter 60, the desired diameter and density of the rain droplets in the umbrella 66 that will take shape in the dousing phase will be achieved, thus ensuring, after experimenting, the biggest firefighting result (Creation of Tables).

Note: The direction of water centrifugation can be combined with the helicopter propeller in order to obtain a better interaction.

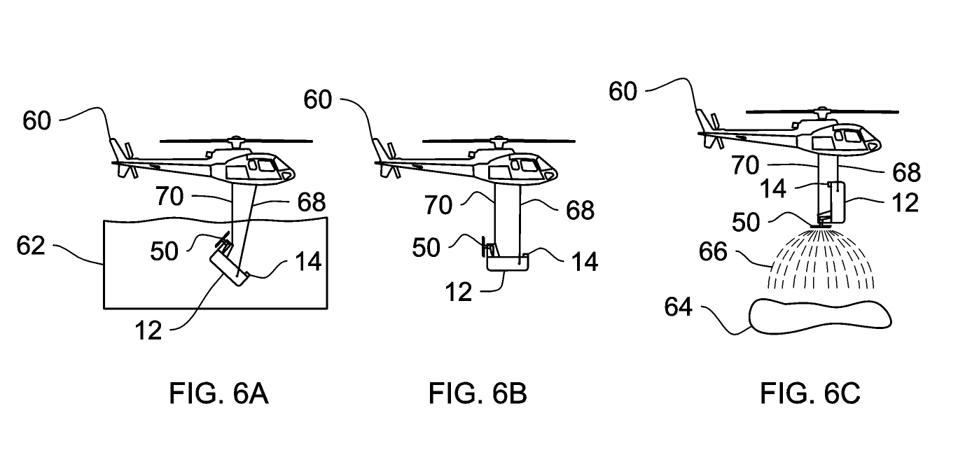

The firefighting process with the RAINSTORM method includes the following stages, as best illustrated in FIGS. 6A-6C:
Filling up of the Reservoir with Water (FIG. 6A). This is achieved with the following ways:
From the Sea, Lakes and rivers, as the current practice.
From manmade Reservoirs of large capacity, having a depth of at least 2.5 m, which either exist or will be constructed near specifically protected areas as: archaeological sites, open air theaters, zoos, gardens, mountains etc.
In the above two cases the helicopter 60 is flown over the supply source 62 and with the help of a winch, operated from within the helicopter 60, the third wire rope 70 which is hooked to the caudal fin 20 is set into operation, lifting thus the tail of the reservoir 12 until its longitudinal axis reaches an angle of approx. 45° to the water level. The helicopter 60 is then lowered progressively and the reservoir 12 sinks under its own weight, and starts to fill up from the wide orifice 14 located at the elevated front end. As soon as the replenishment of the reservoir 12 is completed within a few seconds the caudal wire rope 70 is lifted, the reservoir 12 assumes the horizontal position, as best illustrated in FIG. 6B, the helicopter 60 is lifted and flies to the fire 64.
In addition to the above mentioned methods, the RAINSTORM program gives the possibility to transport backup reservoirs 12 near the fire 64, placing them in open areas (stadiums, fields etc.). These backup reservoirs 12 will be filled up by water tank vehicles of the local authorities and/or private individuals. In this way the helicopters will leave the empty reservoirs for replenishment and pick up in minimum time the filled ones in order to return very rapidly to the fire, thus multiplying the fire fighting force of the helicopters. This is equivalent to a bigger helicopter fleet.
Flying to the Scene of Fire. During this phase, the reservoir 12 is at the horizontal position, as best illustrated in FIG. 6B, in order not to waste any water during transportation from the filling orifice 14, which is also equipped with a non return mechanism 16, as well from the rain creating mechanism 30 which is located over the highest water level of the reservoir 12.
Rain Creation and Fire Fighting. As soon as the helicopter 60 approaches the scene of fire 64 and assumes the proper flight height, the caudal wire rope 70 is slackened until the reservoir 12 assumes the vertical position and the hollow propeller assembly 50 is horizontal, as best illustrated in FIG. 6C.

In this position, under the pressure of the, above water column, the Hydraulic Mechanism Water Turbine 36 is set into automatic operation simultaneously setting the propeller 52 into rotation, while at the same time the incoming water is channeled towards the counterbalancing nozzles 54 and dashes out through them with great momentum intensifying the propellers rotation, and contributing thus in the better centrifugation of water and in the enlargement of shaped rain umbrella 66.

Note: The relative experiments will show which is the optimum number of nozzles, their diameter as well as the reservoir water drop duration, so that in function with the flight level and the helicopters speed, to achieve maximum firefighting results in the ground. Fire Fighting

### Helicopter Method of Operation

In order to have the best possible results in firefighting with the RAINSTORM method, the helicopters must operate in a Systematic Manner, depending on the pattern, the extend and the intensity of the fire.

The way of operation will be decided each time by the responsible person in charge of the Command and Control Center, according to the relative information reported.

As an example, when the front of the fire is relatively narrow, then the helicopters (2 or 3) will attempt one behind the other, maintaining a safety distance, and will fly in a row above the fire front. If however the width of fire front is relatively wide, then the helicopters will fly in shapes, in such a way that the rain umbrellas will cover the whole fire front, for example, in triangular arrangement with one helicopter in front and two behind, or two helicopters in front and three behind and so on.

What has particular importance and must be enforced during all the air missions is the detailed coordination in order to achieve best results with minimum cost. This of course must not go against all security measures, which must at any rate be applied in order to minimize possible disasters and loss of life.

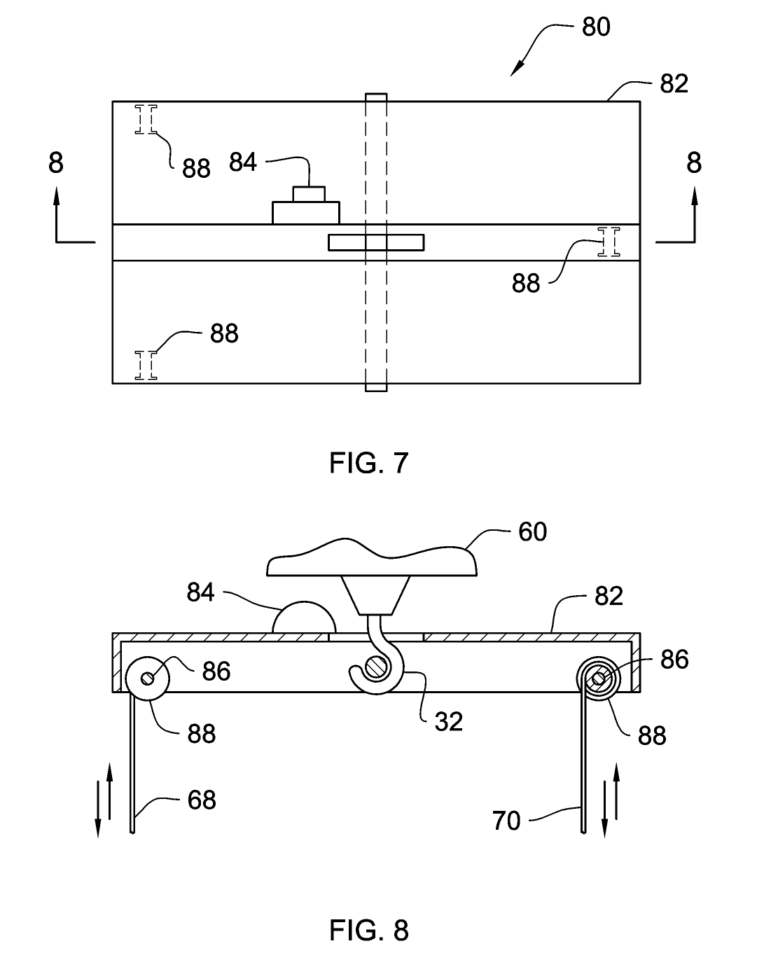

As best illustrated in FIGS. 7 and 8, a reservoir suspension device 80 can be used to suspend and control the angle of the cylindrical reservoir from the aircraft 60. The reservoir suspension device 80 consists of a rectangular shaped frame or stretcher 82 which is removably connected to a hook 61 of the aircraft 60. The stretcher 82 has a general dimension of, but not limited to, 2.00 m (length)×1.00 m (width)×0.20 m (height). The purpose of the stretcher 82 is to strap the three (3) belts 68, 70 from which the cylindrical reservoir is suspended in a triangular arrangement.

The stretcher 82 is fitted with a 12V servomechanism or winch 84, powered from within the aircraft 60. The servomechanism 84 is operated by means of a simple controller located in the aircraft's 60 cockpit.

The servomechanism 84 moves two parallel shafts 86 located on each side of the stretcher 82. One shaft includes drums 88 located at each end thereof with belts 68 wound therearound, and the other shaft includes one drum 88 with belt 70 wound therearound. The belts 68, 70 have a free end of approximately, but not limited to, 70-80 cm. At the end of each belt 68, 70 is included a fast coupler which connects the stretcher 82 with the cylindrical reservoir. The belts 68, 70 have an approximate length of, but not limited to, 10-12 m.

This arrangement allows the rotation of the drums 88 of the stretcher 82 by means of approximately three (3) rotations of the servomechanism 84. This elevates and descends the belts 68, 70 approximately, but not limited to, 70-80 cm, thereby tilting the longitudinal axis of the cylindrical reservoir ±45°, without shifting its center of gravity.

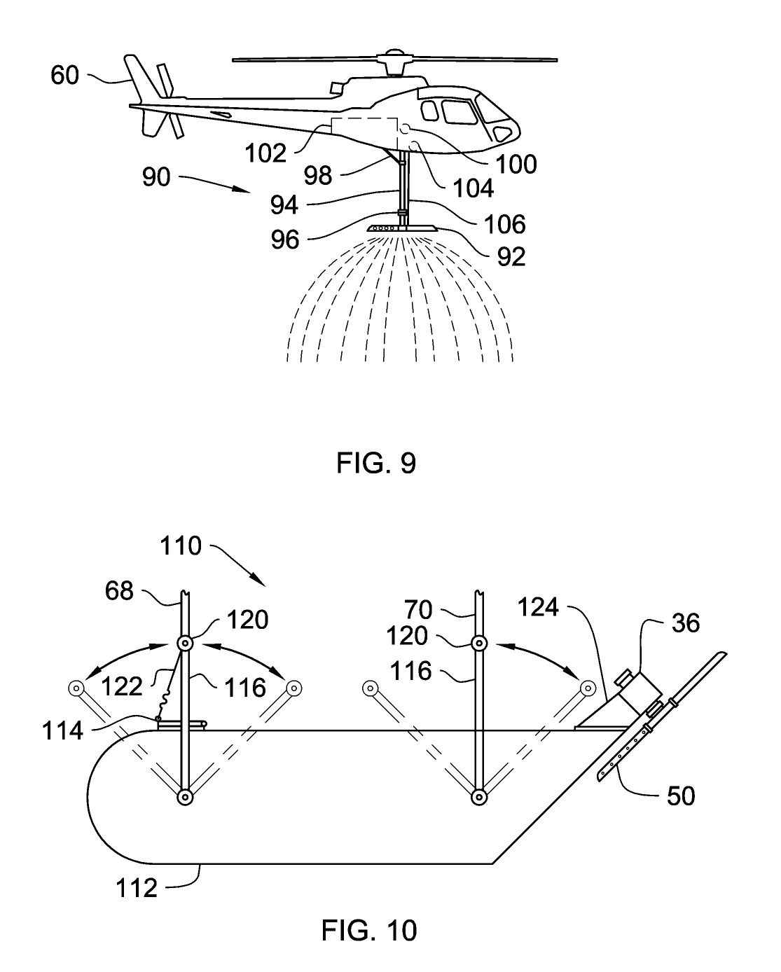

As best illustrated in FIG. 9, the present invention can also be adapted to be used with aircrafts or helicopters 60 having a built-in liquid reservoir 102. A rain creation mechanism and dousing unit 90 includes rotating hollow propellers 92 for the centrifugation of water. The rain creation mechanism and dousing unit 90 has an immediate implementation with heavy fire fighting helicopters or aircrafts that possess a built-in liquid reservoir with a capacity, such as but not limited to, 3-15 m³. In these cases only common industrial equipment can be used.

The rain creation mechanism and dousing unit 90 further includes a reclined or retractable telescopic pipe 94 having a total length of approximately, but not limited to, 3.00 m. The pipe 94 is adapted to and in fluid communication with the helicopter's 60 reservoir, and at the end of which is fitted the hollow propellers 92 through a free rotating mechanism 96 that is in a substantially vertical position to the pipe 94.

The rain creation mechanism and dousing unit 90 can be raised and lowered into position be a hydraulic mechanism 98.

A water pump 100 is used to pump water or liquid from the built-in reservoir 102 to a first element of the telescopic pipe 94, thus protracting the pipe and setting the hollow propellers 92 into rotation. This rotation is accelerated by the downstream air of the helicopter's rotors.

A 12V servomechanism or winch 104 is fitted to the helicopter's floor. A cable 106 connected and operated by the servomechanism 104 is connected to the end of the pipe 94. The cable 106 follows the movement of the pipe 94 during the extension phase, and retracts the pipe once the operation is complete.

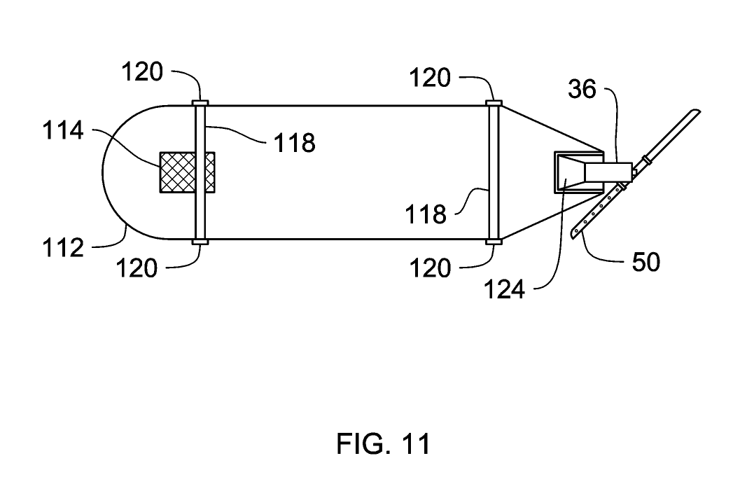

FIGS. 10 and 11 best illustrates an alternate embodiment water reservoir and artificial rain creation mechanism 110. This embodiment includes a cylindrical reservoir 112 having an artificial rain creation and dousing mechanism located on a rear side thereof.

The dimensions of the reservoir 112 and its capacity are standardized in sizes respectively with the lifting capability of helicopters used for firefighting.

The reservoir 112 includes two pivoting suspension assemblies located adjacent to each end of the reservoir 112. Each suspension assembly includes a pair of pivoting suspension arms 116 located on opposite sides of the reservoir 112. Each pair of suspensions arms 116 include a cross arm 118 connected to the free ends of the suspension arms, as best illustrated in FIG. 11.

One pair of suspension arms 116 are located at a front end of the reservoir and include a coupling point 120 located at the free ends of each suspension arm. The other pair of suspension arms 116 includes a single coupling point 120 centrally located on said coupling arm 118.

The reservoir 112 is suspended from the helicopters by means of three wire ropes or belts 68, 70, which are fixed with couplers to a corresponding coupling point 120, thereby forming a triangular arrangement.

The reservoir 112 is manufactured from material durable in marine water, having a powerful frame in order to withstand all load strains and vibrations caused by the various helicopter maneuvers especially during the dousing phase. The rear end of the reservoir 112 is an angled planar surface with an angle of approximately 45°.

In an upper front compartment of the reservoir 112 there is a specifically shaped and elevated intake orifice featuring a valve 114 used for the replenishment of the reservoir 112 with water. The valve 114 opens and closes automatically during the three phases of operation of the reservoir 112 by way of a spring or line 122 connected to the cross arm 118 of the front end located suspension arms 116. Thus, when the front end suspension arms 116 are pivoted in one direction, the spring 122 is pulled thereby opening the valve 114.

The water reservoir and artificial rain creation mechanism 110 further includes a rain creation and dousing unit, manufactured from stainless material. The rain creation and dousing unit includes an angled conical pipe 124 which channels the water to a hydraulic mechanism and water turbine 36, and a hollow propeller assembly 50. The pipe 124 is parallel with the angle of the rear end of the reservoir 112.

The hydraulic mechanism and water turbine 36 is fitted with the ported bladed trunions for channeling the pressurized water to the hollow propeller assembly 50. The hollow propeller assembly 50 includes a plurality of propellers each with multiple nozzles each having an appropriate diameter to form a rain umbrella that will take shape in the dousing phase. The hollow propeller assembly 50 is water tightly connected and in fluid communication with the hydraulic mechanism and water turbine 36, and is angle so as to be parallel with the angle of the rear end of the reservoir 112.

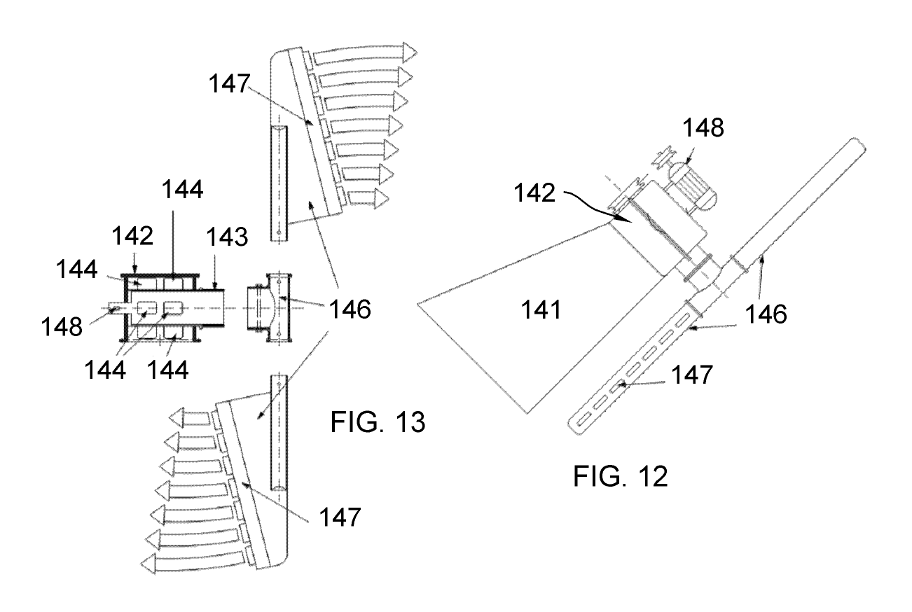

The Rain Creation Mechanism (FIGS. 12 and 13), consists of a conical pipe 141 which receives the water from the reservoir's upper aft side, and drives it to a hollow shaft whirl 142. On this hollow shaft 143, which at this phase is in a vertical position and between its fins 144, there are windows through which the water enters into the hollow shaft and it is then directed to the twin blade hollow propeller 146, which is firmly connected with the whirl's axis and turns alongside with it.

Each blade has at its back side, a set of nozzles in counter position (5-10 on each blade) 147, and have a rectangular cross section. The water is centrifuged and exits the nozzles with high pressure creating a rain umbrella, thus contributing to the rotation of the hollow shaft. (Whirl phenomenon of the ancient Greek inventor Heron of Alexandria).

Note: Since the rotational speed of the hollow shaft depends, among other things, to the water level inside the reservoir, the installation of a 12 V DC motor 148 is foreseen at the other end (closed end) of the whirl's shaft. This contributes in the creation of a uniform rain umbrella, regardless of the water quantity available inside the reservoir.

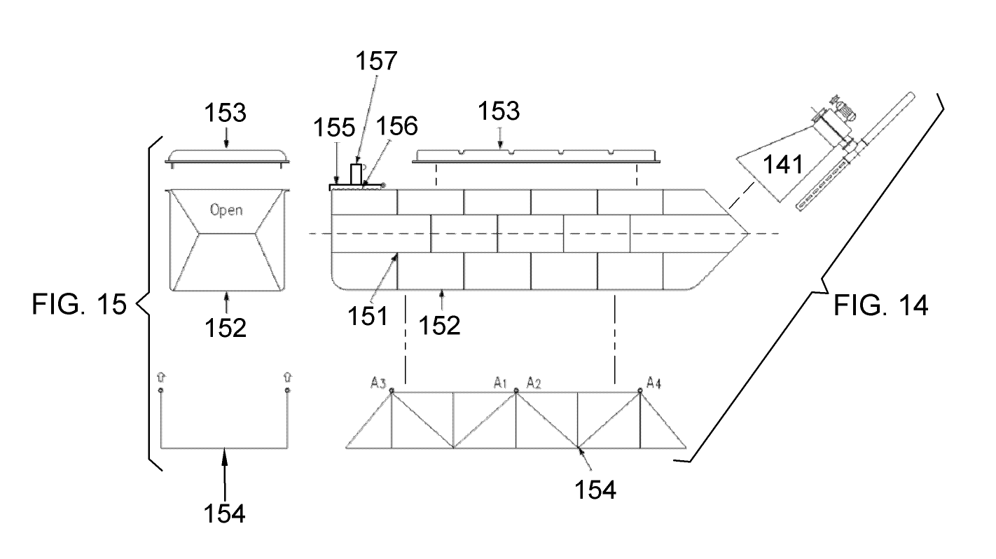

The RAINSTORM suspended reservoir (FIGS. 14 and 15). This is an elongated symmetrical reservoir, made of plastic, metallic or a combination of both materials, in order to reduce weight (to the benefit of firefighting liquid), and at the same time possess high mechanical strength in order to withstand the expected oscillations during helicopter flight and touch downs.

Following appropriate design, a combined material construction was chosen for the reservoir, with metallic frame 151 and plastic outer casing 152 and cover 153. Furthermore the swing, on which the reservoir will be safely fixed, has robust metal construction 154. Four common chains will be fixed in cross shape at the upper side of the swing, and which will connect/disconnect via fast couplers to the respective ends (ring joints) of the stretcher.

At the upper front side of the reservoir, a rectangular intake manifold is fitted 155, used for water intake. Water can be used from different sources, so the manifold is fitted with a mechanical screen 156 in order to avoid solids entering the reservoir. An opening at the top of the intake manifold ensures atmospheric pressure inside the reservoir 157.

At the back side of the reservoir and at an inclination angle of 45° the rain creation mechanism is fitted.

The swing 154. It is a robust metallic lattice construction, on which the complete system of the reservoir together with the rain creation mechanism will be belt strapped. At its upper side there are 4 points/rings A1, A2, A3 & A4 where the chains coming from the respective rings of the stretcher will be connected via fast couplers. The selection of chains was made due to their unique capability to collapse to the ground during the helicopter's touchdown.

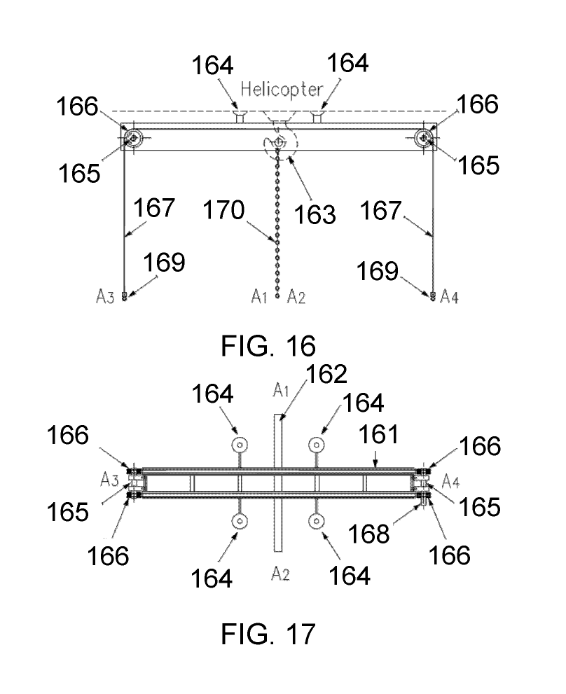

The suspension stretcher (FIGS. 16 and 17). The suspension stretcher is a strong rectangular metal frame 161, with indicative dimensions of 2.00×0.20×0.15 (m) (L×D>H). The stretcher will have a steel shaft 162 running laterally at its middle where the helicopter's hook 163 will be fastened. In this way the helicopter's touchdown will not be hindered, even when the stretcher is fitted. (When the reservoir touches the ground, the helicopter lands next to it). The suspension stretcher is fixed into the helicopter's under side via 4 cylindrical metal beakers 164 placed in a square layout (0.50×0.50 m), with elastic heads (suction heads), which are mechanically lifted and come in full contact with the helicopter's underside, thus making a solid connection.

At both ends of the stretcher there are 2 parallel steel shafts 165, on which 4 sprocket wheels are fitted (just like the wheels on a small car) 166. These parallel shafts are bridged with 2 parallel chains 167, one on each side (left and right) of the helicopter's hook. At the end side of one of the shafts, a 12 V DC servomechanism 168 is fitted and electrically fed by the helicopter's electrical system.

The ends of the two chains running from each shaft are connected with a metal rod 169, at an approximate length of 1.00 m below the sprocket wheels. At the middle of this rod there is a ring (suspension points A3, A4), where the chains connecting the respective rings (A3, A4) of the swing are coupled via fast couplers.

The suspension stretcher's central shaft length is the same as the reservoir swing's width. It has two rings at both ends (suspension points A1, A2) where the two main chains of constant length are fitted, and which are connected respectively to the suspension points A1, A2 of the swing. These rings are designed and fitted on either side (left and right) of the filled to capacity reservoir's center of gravity. This design provides, through the operation of the servomechanism, the capability to provide the required inclination to the longitudinal axis of the reservoir (−45°, 0°, +45°), thus always maintaining the suspended system's center of gravity at a constant height.

### Operation of the Rainstorm System

Filling the reservoir with water. This can be achieved with the following methods:

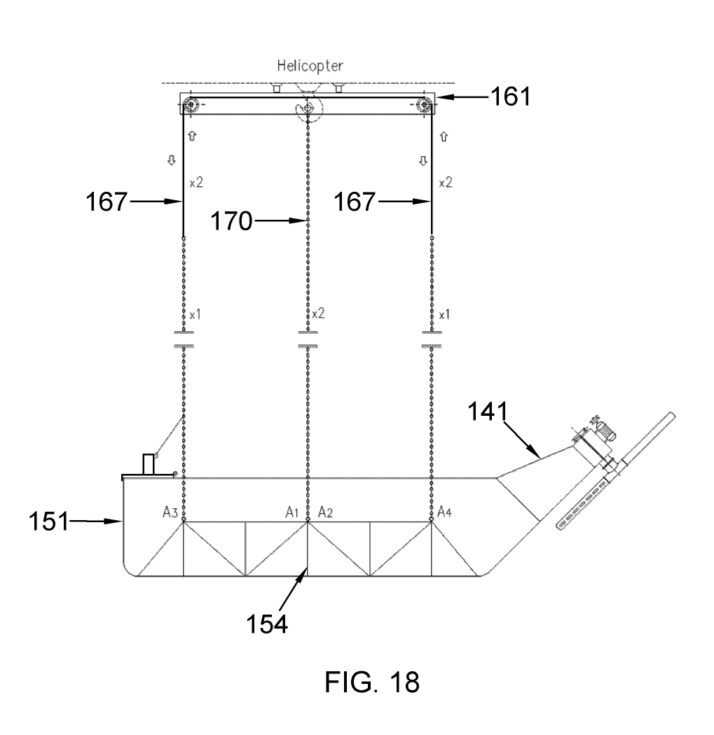

a. On the ground by means of water tankers, or fire hydrants, via the elevated intake manifold on top of the reservoir 157 (FIG. 18).

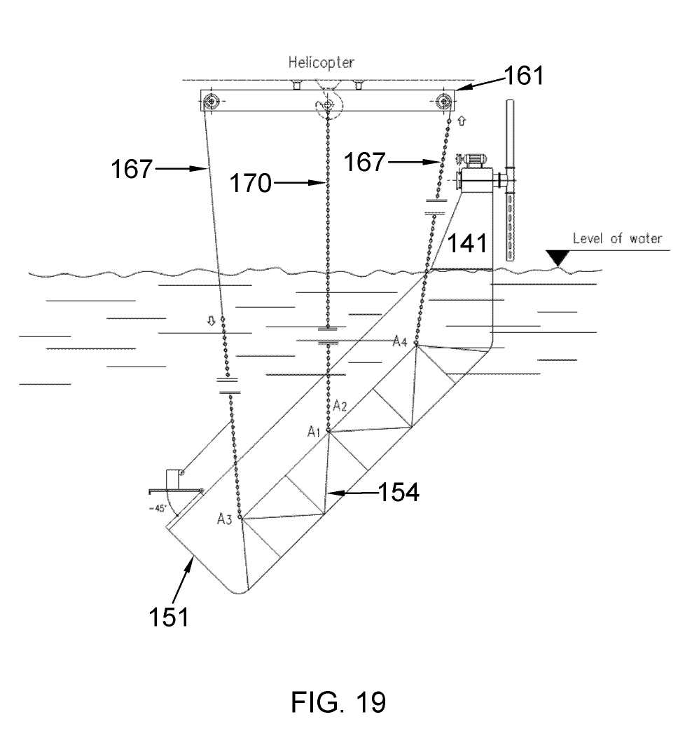

b. By sea, lake or river. In these cases, once the helicopter reaches the replenishment source the pilot controlling the servomechanism of the suspension stretcher tilts the front side of the reservoir at an inclination of −45°, and slowly approaches the water level (FIG. 19).

The reservoir is then slowly immersed into the water, with the intake manifold at its open position. The reservoir begins to immerse on its own weight (approx. 350-400 kg), and the immersion process is completed when the rain creation mechanism is also fully under water. This stage continues and the reservoir is “surfing” under water for approximately 10-20 sec, until the reservoir is filled to capacity (the intake manifold has dimensions of 0.30×0.30 m). The controlling servomechanism then begins to level the reservoir, the intake manifold closes automatically, and the helicopter transports the filled reservoir to the fire at a steady speed.

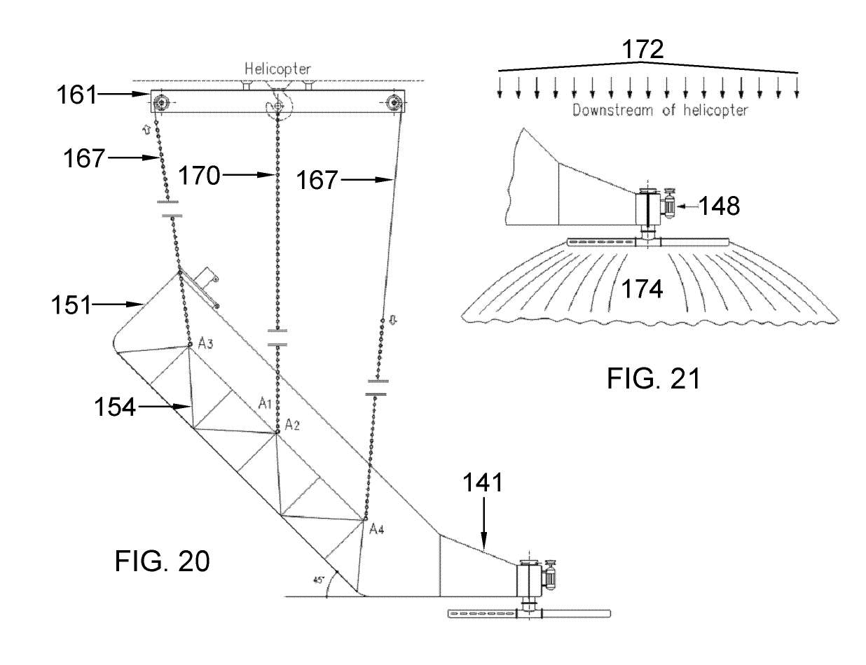

Fire Fighting. The pilot, once he reaches the fire, assesses the situation and decides on the course of action. He selects the flight level and by controlling the servomechanism the reservoir is tilted at an inclination of +45°, at which point the rain creation mechanism and the hollow propeller assume a horizontal position (FIGS. 20 and 21). At this phase the water flows downwards and sets the whirl along with the twin blade hollow propeller into motion, thus spreading and centrifuging the water, which dashes out from the two sets of counter placed nozzles. This effect creates a parabolic rain umbrella 174 (FIG. 21). This is further enhanced by the continuous downstream 172 (FIG. 21) created by the helicopter's main rotor. The helicopter's downstream forces into the rain umbrella, creating further swirl, homogenizing even further the rain fall and pushes it towards the fire.

Note: When the hollow propeller reaches the horizontal position, the auxiliary 12 V DC motor 148 (FIG. 21) is automatically set into operation in order to maintain a constant rotational speed of the hollow propeller. This will ensure that the rain umbrella created is as homogeneous as possible.

It is understood that, depending on the situation, the pilot can suspend and resume the creation of rain, having in mind the total time in seconds available before the reservoir is emptied.

Note: The “RAINSTORM” system has been studied and designed as an integrated, unified and indivisible system. All of its subsystems operate flawlessly with each other, in order to achieve the creation of artificial rain with the required characteristics, leading to the fastest, safest and most economical way to achieve the Maximum Fire Fighting Result.

While embodiments of the aircraft fire extinguishing system and method have been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. And although extinguishing fires using aircraft have been described, it should be appreciated that the aircraft fire extinguishing system and method herein described is also suitable for dispensing substances, such as but not limited to, insecticide, herbicide, fertilizer or seeds onto the ground from an aircraft.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A fire extinguishing system for a creation of artificial rain by utilizing 100% of a liquid carried by a firefighting helicopter, said fire extinguishing system comprising:
a reservoir configured to retain a liquid therein;
a whirl having a hollow shaft in communication with said reservoir and configured to receive the liquid from said reservoir, said hollow shaft having a plurality of fins with a window defined between said fins configured to allow the liquid to enter said hollow shaft; and
a hollow propeller connected to an axis of said whirl, said hollow propeller being in communication with said hollow shaft and configured to receive the liquid from said hollow shaft, said hollow propeller having at least two blades each with a set of nozzles configured to create an artificial rain;
wherein said artificial rain from said hollow propeller has an umbrella shape with a diameter approximately equal to a diameter of a main rotor of the helicopter, said artificial rain possesses predetermined characteristics of density, intensity and duration.

2. The aircraft fire extinguishing system according to claim 1 further comprising a swing configured to support said reservoir and suspend said reservoir from the helicopter.

3. The aircraft fire extinguishing system according to claim 2 further comprising a suspension stretcher fitted to an underside of the helicopter via four elastic suction heads, and to a hook of the helicopter.

4. The aircraft fire extinguishing system according to claim 3, wherein said stretcher further comprising at least four sprocket wheels with two parallel chains moving on each side of the hook by means of a 12 V DC servomechanism, said chains are connected and end up at two points of said swing.

5. The aircraft fire extinguishing system according to claim 4, wherein said servomechanism is configured to control a required inclination of −45°, 0°, +45° of said reservoir firmly attached to said swing, said chains are configured to receive part of a total weight of a suspended load which is suspended from the helicopter.

6. The aircraft fire extinguishing system according to claim 5, wherein a main axis of said suspension stretcher, passing through the hook of the helicopter, receives a largest amount of the total weight of the suspended load, by means of said two chains connected to its edges, said chains have a constant length of substantially 5.0 m, and said chains end up at said two points of said swing, which are located on either side of a center of gravity the suspended load.

7. A aircraft fire extinguishing system comprising:
a reservoir having a front end and a rear end, said reservoir being configured to retain a liquid therein;
a conical pipe in communication with said reservoir and configured to receive the liquid from said reservoir;
a whirl having a hollow shaft in communication with said conical pipe and configured to receive the liquid from said conical pipe, said hollow shaft having a plurality of fins with a window defined between said fins configured to allow the liquid to enter said hollow shaft;
a hollow propeller connected to an axis of said whirl, said hollow propeller being in communication with said hollow shaft and configured to receive the liquid from said hollow shaft, said hollow propeller having at least two blades;
a set of nozzles are located at a back side of each of said blades placed in a counter position to each other, said nozzles each have a rectangular cross section, said nozzles are configured to dispense the liquid in a form of a film, and to centrifuged the liquid to contribute to a rotation of said hollow propeller; and
a 12 V DC electric motor fitted at a closed end of said hollow shaft of said whirl, said motor being configured to ensure a constant rate of rotation of said hollow propeller, regardless of a quantity of the liquid inside said reservoir at any given moment, said motor being configured to start operating a moment said hollow propeller assumes a horizontal position.
wherein said whirl is set into rotary motion by the liquid, turning subsequently said hollow propeller.

8. The aircraft fire extinguishing system according to claim 7 further comprising a means for suspending said reservoir, said means comprising:
a swing configured to support said reservoir;
a suspension stretcher fitted to an underside of the aircraft via four elastic suction heads, and to a hook of the aircraft; and
at least four sprocket wheels with two parallel chains moving on each side of the hook by means of a 12 V DC servomechanism, said chains are connected and end up at two points of said swing, said servomechanism is configured to control a required inclination of −45°, 0°, +45° of said reservoir firmly attached to said swing, said chains are configured to receive part of a total weight of a suspended load which is suspended from the aircraft;
wherein a main axis of said suspension stretcher, passing through the hook of the aircraft, receives a largest amount of the total weight of the suspended load, by means of said two chains connected to its edges, said chains have a constant length of substantially 5.0 m, and said chains end up at said two points of said swing, which are located on either side of a center of gravity the suspended load.
